(19) United States
(12) Patent Application Publication
(10) Pub. No.: US 2005/0270769 A1
(43) Pub. Date: Dec. 8, 2005

(54) Closer look

(76) Inventor: Vivienne Smith, Hagerstown, MD (US)

Correspondence Address: Emery L. Tracy, P.O. Box 1518, Boulder, CO, 80306, US

(21) Appl. No.: 10/860,075

(22) Filed: Jun. 4, 2004

(51) Int. Cl. F21V 33/00

(52) U.S. Cl. 362/109; 362/253

(57) ABSTRACT

A body inspection device for allowing a user to inspect areas of the body not readily seen by the user. The body inspection device includes a mirror assembly being designed for reflecting an image of a portion of the body to be viewed by the user. A handle assembly is coupled to the mirror assembly whereby the handle assembly is for permitting selective positioning of the mirror assembly. The handle assembly is designed for being gripped in a hand of the user to allow the user to support the mirror assembly. A light assembly is coupled to the mirror assembly. The mirror assembly is for emitting light whereby the light emitting assembly is designed for illuminating the portion of the body being viewed by the user when the light assembly is actuated by the user.

### I. BACKGROUND OF THE INVENTION

The present invention relates to anatomical self-examination systems and more particularly pertains to a new body inspection device for allowing a user to inspect areas of the body not readily seen by the user.

### II. DESCRIPTION OF THE PRIOR ART

The use of anatomical self examination systems is known in the prior art. U.S. Pat. No. 2,192,158 describes a system for permitting the user to see themselves from a variety of angles. Another type of anatomical self examination system is U.S. Pat. No. 404,021 having a dental mirror that can be adjusted to provide the user with different angles of viewing the interior of the mouth. U.S. Pat. No. 4,925,285 has a support frame with a plurality of mirrors coupled to the support frame to allow the user to view the body from different angles.

While these devices fulfill their respective, particular objectives and requirements, the need remains for a system that has certain improved features that allow the mirrors to be positioned in the best positioned possible for the user to view the portion of the body the user wishes to view.

### III. SUMMARY OF THE INVENTION

The present invention meets the needs presented above by providing a handle assembly that can be bent to a desired position to provide the best angle for the mirror assembly to reflect the image of the portion of the body to be viewed.

To this end, the present invention generally comprises a mirror assembly being designed for reflecting an image of a portion of the body of the user to be viewed by the user to allow the user to inspect the body. A handle assembly is coupled to the mirror assembly whereby the handle assembly is for permitting selective positioning of the mirror assembly when the user uses the mirror assembly to view the desired portion of the body. The handle assembly is designed for being gripped in a hand of the user to allow the user to support the mirror assembly when the mirror assembly is being used view the body of the user. A light assembly is coupled to the mirror assembly. The mirror assembly is for emitting light whereby the light emitting assembly is designed for illuminating the portion of the body being viewed by the user when the light assembly is actuated by the user.

There has thus been outlined, rather broadly, the more important features of a body inspection device in order that the detailed description thereof that follows may be better understood, and in order that the present contribution to the art may be better appreciated. There are additional features of the body inspection device that will be described hereinafter and which will form the subject matter of the claims appended hereto.

In this respect, before explaining at least one embodiment of the body inspection device in detail, it is to be understood that the body inspection device is not limited in its application to the details of construction and to the arrangements of the components set forth in the following description or illustrated in the drawings. The body inspection device is capable of other embodiments and being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the designing of other structures, methods and systems for carrying out the several purposes of the present body inspection device. It is important, therefore, that the claims be regarded as including such equivalent constructions insofar as they do not depart from the spirit and scope of the present invention.

It is therefore an object of present invention to provide a new body inspection device that illuminates the portion of the body to be inspected.

It is another object of the present invention to provide a new body inspection device that provides the ability to view a magnified image of the portion of the body to be viewed.

It is another object of the present invention to provide a body inspection device which has all of the advantages of the prior art and none of the disadvantages.

It is another object of the present invention to provide a body inspection device which may be easily and efficiently manufactured and marketed.

It is another object of the present invention to provide a body inspection device which is of durable and reliable construction.

It is yet another object of the present invention to provide a body inspection device which is economically affordable and available for relevant market segment of the purchasing public.

Other objects, features and advantages of the present invention will become more readily apparent from the following detailed description of the preferred embodiment when considered with the attached drawings and appended claims.

### IV. BRIEF DESCRIPTION OF THE DRAWINGS

FIG. 1 is a front perspective view of a new the body inspection device according to the present invention.

FIG. 2 is a rear perspective view of the mirror assembly and the side mirror assemblies of the present invention.

FIG. 3 is a schematic view of the light assembly of the present invention.

### V. DESCRIPTION OF THE PREFERRED EMBODIMENT

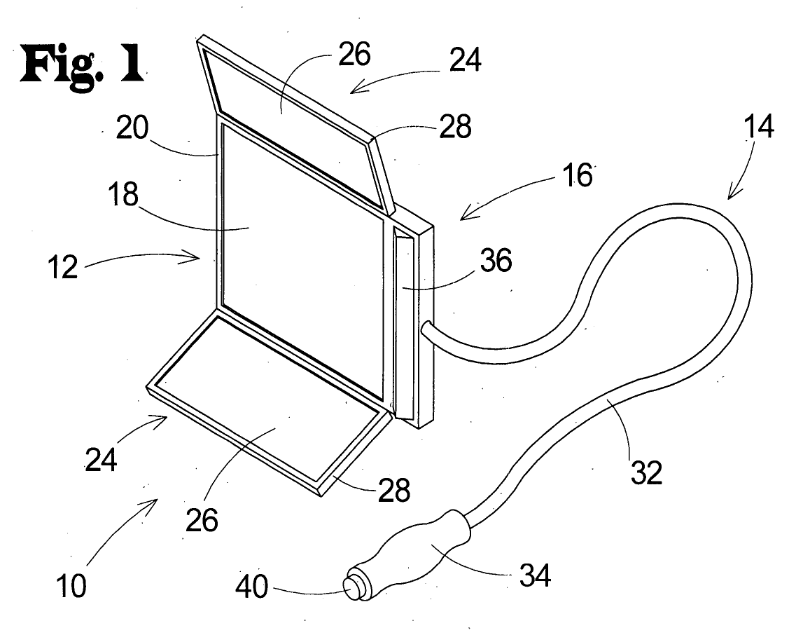

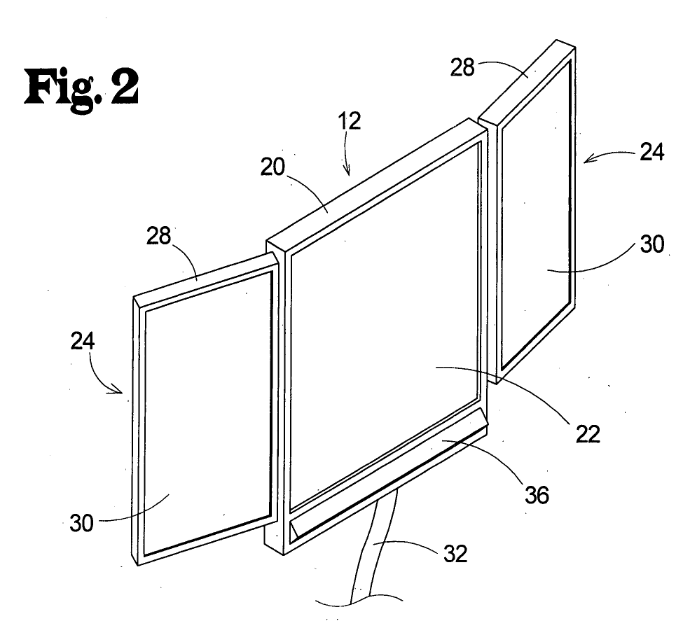

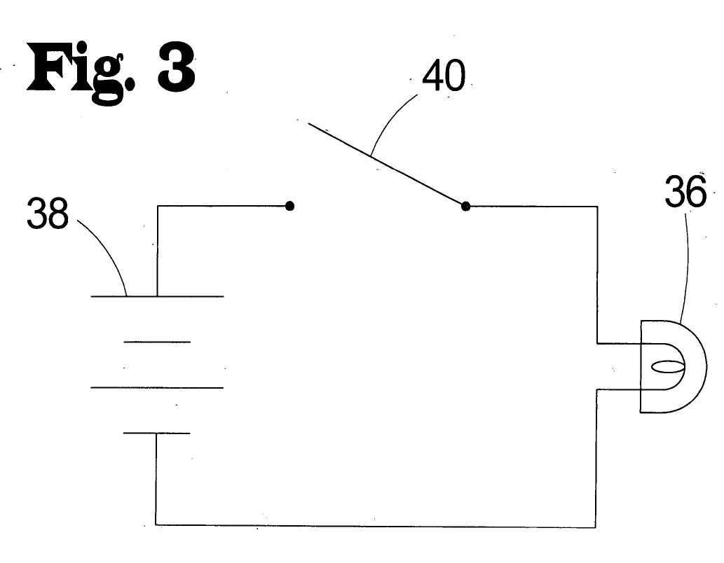

With reference now to the drawings, and in particular to FIGS. 1 through 3 thereof, a new the body inspection device embodying the principles and concepts of the present invention and generally designated by the reference numeral 10 will be described.

As best illustrated in FIGS. 1 through 3, the the body inspection device 10 generally comprises a mirror assembly 12 being designed for reflecting an image of a portion of the body of the user to be viewed by the user to allow the user to inspect the body. The mirror assembly 12 has a length of about 4 inches and a width of about 4 inches.

A handle assembly 14 is coupled to the mirror assembly 12 whereby the handle assembly 14 is for permitting selective positioning of the mirror assembly 12 when the user uses the mirror assembly 12 to view the desired portion of the body. The handle assembly 14 is designed for being gripped in a hand of the user to allow the user to support the mirror assembly 12 when the mirror assembly 12 is being used view the body of the user.

A light assembly 16 is coupled to the mirror assembly 12. The mirror assembly 12 is for emitting light whereby the light emitting assembly is designed for illuminating the portion of the body being viewed by the user when the light assembly 16 is actuated by the user.

The mirror assembly 12 comprises a base mirror member 18 and a frame member 20. The base mirror member 18 is coupled to the frame member 20 whereby the frame member 20 extends around the base mirror member 18. The frame member 20 is coupled to the light assembly 16 and the handle assembly 14. The base mirror member 18 is designed for reflecting the image of the portion of the body to be viewed by the user.

The mirror assembly 12 comprises a magnifying mirror member 22. The magnifying mirror member 22 is coupled to the frame member 20 of the mirror assembly 12 whereby the magnifying mirror member 22 is positioned opposite the base mirror member 18. The magnifying mirror member 22 is designed for providing an enlarged view of the portion of the body to be viewed by the user when the magnifying mirror member 22 is directed toward the portion of the body to be viewed.

A pair of side mirror assemblies 24 are hingably coupled the frame member 20 of the mirror assembly 12. Each of the side mirror assemblies 24 is selectively angled with respect to the mirror assembly 12. Each of the side mirror assemblies 24 is designed for reflecting an image the portion of the body to be viewed by the user from a different angle when the side mirror assemblies 24 are angled with respect to the mirror assembly 12. Each of the side mirror assemblies 24 has a length of about 4 inches and a width of about 1 1/2 inches.

Each of the side mirror assemblies 24 comprises a base side mirror member 26 and a chassis member 28. The chassis member 28 is coupled to the base side mirror member 26 of the associated one of the side mirror assemblies 24 whereby the chassis member 28 extends around the base side mirror assembly 12 of the associated one of the side mirror assemblies 24. The chassis member 28 of each of the side mirror assemblies 24 is hingably coupled to the frame member 20 of the mirror assembly 12. The base side mirror member 26 is designed for reflecting the image of the portion of the body to be viewed for the user to view the base side mirror member 26 of each of the side mirror assemblies 24 is directed towards to the portion of the body to be viewed.

Each of the side mirror assemblies 24 comprises a magnifying side mirror member 30. The magnifying side mirror member 30 is coupled to the chassis member 28 of the associated one of the side mirror assemblies 24 whereby the magnifying side mirror member 30 is positioned opposite the base side mirror member 26 of the associated one of the side mirror assemblies 24. The magnifying side mirror member 30 is designed for magnifying the image of the portion of the body to be viewed by the user when the magnifying side mirror member 30 of each of the side mirror assemblies 24 is directed towards the portion of the body the user wishes to view.

The handle assembly 14 comprises an extension member 32 and a grip member 34. The extension member 32 is coupled to the frame member 20 of the mirror assembly 12. The grip member 34 is coupled to the extension portion whereby the grip member 34 is positioned opposite the mirror assembly 12. The extension member 32 is designed for being selectively bent by the user to allow the user to selectively position the mirror assembly 12 to view the desired portion of the body. The grip member 34 is designed for being gripped by a hand of the user to allow the user to hold the mirror assembly 12 in the desired position. The extension member 32 of the handle assembly 14 comprises a resiliently flexible material. The resiliently flexible material is designed for allowing the extension member 32 to be bent into a desired shape to allow selective positioning of the mirror assembly 12 and retaining that shaped until the user bends the extension member 32 again. The extension member 32 of the handle assembly 14 has a length of about 18 inches.

The light assembly 16 comprises a light emitting member 36 and a power supply 38. The power supply 38 is positioned in the handle assembly 14. The light emitting member 36 is operationally coupled to the power supply 38 whereby the power supply 38 is for supplying power to the light emitting member 36. The light emitting member 36 is designed for emitting light when the power supply 38 is supplying power to the light emitting member 36. The light emitting member 36 is coupled to the frame member 20 of the mirror assembly 12 whereby the light emitting member 36 is designed for emitting light to illuminate the portion of the body is viewed in the mirror assembly 12.

The light assembly 16 comprises a switch member 40. The switch member 40 is operationally coupled between the light emitting member 36 and the power supply 38 whereby the switch member 40 is for controlling the supply of power from the power supply 38 to the light emitting member 36 when the switch member 40 is actuated by the user. The switch member 40 is coupled to the grip portion the handle assembly 14 whereby the switch member 40 is designed for being actuated by the user when the user is gripping the grip member 34 of the handle assembly 14.

In use, the user bends the extension member 32 of the handle assembly 14 into a shape that will allow the user to view the desired portion of the body to be inspected. The side mirror assemblies 24 are then angled with respect to the mirror assembly 12 to allow the user to view the desired portion of the body to be inspected from a different angle. The switch member 40 is then actuated by the user when the user is gripping the grip member 34 to allow power to be supplied to the light emitting member 36 to allow the light member to illuminate the portion of the body to be inspected. The user can use either the base mirror member 18 and the base side mirror member 26s to obtain a generalized view of the portion of the body to be inspected. Alternately, the user may use the magnifying mirror member 22 and the magnifying side mirror member 30s to allow the user to viewed a magnified image of the portion of the body being inspected by the user.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. A body inspection device for allowing a user to inspect areas of a body of the user that are not easily viewed by the user, the body inspection device comprising:
(a) a mirror assembly being adapted for reflecting an image of a portion of the body of the user to be viewed by the user to allow the user to inspect the body,
(b) a handle assembly being coupled to said mirror assembly such that said handle assembly is for permitting selective positioning of said mirror assembly when the user uses said mirror assembly to view the desired portion of the body, said handle assembly being adapted for being gripped in a hand of the user to allow the user to support said mirror assembly when said mirror assembly is being used view the body of the user, and
(c) a light assembly being coupled to said mirror assembly, said mirror assembly being for emitting light such that said light emitting assembly is adapted for illuminating the portion of the body being viewed by the user when said light assembly is actuated by the user.

2. The body inspection device as set forth in claim 1, further wherein said mirror assembly comprises a base mirror member and a frame member, said base mirror member being coupled to said frame member such that said frame member extends around said base mirror member, said frame member being coupled to said light assembly and said handle assembly, said base mirror member being adapted for reflecting the image of the portion of the body to be viewed by the user.

3. The body inspection device as set forth in claim 2, further wherein said mirror assembly comprises a magnifying mirror member, said magnifying mirror member being coupled to said frame member of said mirror assembly such that said magnifying mirror member is positioned opposite said base mirror member, said magnifying mirror member being adapted for providing an enlarged view of the portion of the body to be viewed by the user when said magnifying mirror member is directed toward the portion of the body to be viewed.

4. The body inspection device as set forth in claim 1, further wherein a pair of side mirror assemblies is hingably coupled to said mirror assembly, each of said side mirror assemblies being selectively angled with respect to said mirror assembly, each of said side mirror assemblies being adapted for reflecting an image the portion of the body to be viewed by the user from a different angle when said side mirror assemblies are angled with respect to said mirror assembly.

5. The body inspection device as set forth in claim 4, further wherein each of said side mirror assemblies comprises a base side mirror member and a chassis member, said chassis member being coupled to said base side mirror member of the associated one of said side mirror assemblies such that said chassis member extends around said base side mirror assembly of the associated one of said side mirror assemblies, said chassis member of each of said side mirror assemblies being hingably coupled to said mirror assembly, said base side mirror member being adapted for reflecting the image of the portion of the body to be viewed for the user to view said base side mirror member of each of said side mirror assemblies is directed towards to the portion of the body to be viewed.

6. The body inspection device as set forth in claim 5, further wherein each of said side mirror assemblies comprises a magnifying side mirror member, said magnifying side mirror member being coupled to said chassis member of the associated one of said side mirror assemblies such that said magnifying side mirror member is positioned opposite said base side mirror member of the associated one of said side mirror assemblies, said magnifying side mirror member being adapted for magnifying the image of the portion of the body to be viewed by the user when said magnifying side mirror member of each of said side mirror assemblies is directed towards the portion of the body the user wishes to view.

7. The body inspection device as set forth in claim 1, further wherein said handle assembly comprises an extension member and a grip member, said extension member being coupled to said mirror assembly, said grip member being coupled to said extension portion such that said grip member is positioned opposite said mirror assembly, said extension member being adapted for being selectively bent by the user to allow the user to selectively position said mirror assembly to view the desired portion of the body, said grip member being adapted for being gripped by a hand of the user to allow the user to hold said mirror assembly in the desired position.

8. The body inspection device as set forth in claim 7, further wherein said extension member of said handle assembly comprises a resiliently flexible material, said resiliently flexible material being adapted for allowing said extension member to be bent into a desired shape to allow selective positioning of said mirror assembly and retaining that shaped until the user bends said extension member again.

9. The body inspection device as set forth in claim 1, further wherein said light assembly comprises a light emitting member and a power supply, said power supply being positioned in said handle assembly, said light emitting member being operationally coupled to said power supply such that said power supply is for supplying power to said light emitting member, said light emitting member being adapted for emitting light when said power supply is supplying power to said light emitting member, said light emitting member being coupled to said mirror assembly such that said light emitting member is adapted for emitting light to illuminate the portion of the body being viewed in said mirror assembly.

10. The body inspection device as set forth in claim 9, further wherein said light assembly comprises a switch member, said switch member being operationally coupled between said light emitting member and said power supply such that said switch member is for controlling the supply of power from said power supply to said light emitting member when said switch member is actuated by the user, said switch member being coupled to said handle assembly such that said switch member is adapted for being actuated by the user when the user is gripping said handle assembly.

11. A body inspection device for allowing a user to inspect areas of a body of the user that are not easily viewed by the user, the body inspection device comprising
(a) a mirror assembly being adapted for reflecting an image of a portion of the body of the user to be viewed by the user to allow the user to inspect the body,
(b) a handle assembly being coupled to said mirror assembly such that said handle assembly is for permitting selective positioning of said mirror assembly when the user uses said mirror assembly to view the desired portion of the body, said handle assembly being adapted for being gripped in a hand of the user to allow the user to support said mirror assembly when said mirror assembly is being used view the body of the user,
(c) a light assembly being coupled to said mirror assembly, said mirror assembly being for emitting light such that said light emitting assembly is adapted for illuminating the portion of the body being viewed by the user when said light assembly is actuated by the user,
(d) wherein said mirror assembly comprises a base mirror member and a frame member, said base mirror member being coupled to said frame member such that said frame member extends around said base mirror member, said frame member being coupled to said light assembly and said handle assembly, said base mirror member being adapted for reflecting the image of the portion of the body to be viewed by the user,
(e) further wherein said mirror assembly comprises a magnifying mirror member, said magnifying mirror member being coupled to said frame member of said mirror assembly such that said magnifying mirror member is positioned opposite said base mirror member, said magnifying mirror member being adapted for providing an enlarged view of the portion of the body to be viewed by the user when said magnifying mirror member is directed toward the portion of the body to be viewed,
(f) a pair of side mirror assemblies being hingably coupled said frame member of said mirror assembly, each of said side mirror assemblies being selectively angled with respect to said mirror assembly, each of said side mirror assemblies being adapted for reflecting an image the portion of the body to be viewed by the user from a different angle when said side mirror assemblies are angled with respect to said mirror assembly
(g) wherein each of said side mirror assemblies comprises a base side mirror member and a chassis member, said chassis member being coupled to said base side mirror member of the associated one of said side mirror assemblies such that said chassis member extends around said base side mirror assembly of the associated one of said side mirror assemblies, said chassis member of each of said side mirror assemblies being hingably coupled to said frame member of said mirror assembly, said base side mirror member being adapted for reflecting the image of the portion of the body to be viewed for the user to view said base side mirror member of each of said side mirror assemblies is directed towards to the portion of the body to be viewed,
(h) wherein each of said side mirror assemblies comprising a magnifying side mirror member, said magnifying side mirror member being coupled to said chassis member of the associated one of said side mirror assemblies such that said magnifying side mirror member is positioned opposite said base side mirror member of the associated one of said side mirror assemblies, said magnifying side mirror member being adapted for magnifying the image of the portion of the body to be viewed by the user when said magnifying side mirror member of each of said side mirror assemblies is directed towards the portion of the body the user wishes to view,
(i) wherein said handle assembly comprising an extension member and a grip member, said extension member being coupled to said frame member of said mirror assembly, said grip member being coupled to said extension portion such that said grip member is positioned opposite said mirror assembly, said extension member being adapted for being selectively bent by the user to allow the user to selectively position said mirror assembly to view the desired portion of the body, said grip member being adapted for being gripped by a hand of the user to allow the user to hold said mirror assembly in the desired position,
(j) wherein said extension member of said handle assembly comprising a resiliently flexible material, said resiliently flexible material being adapted for allowing said extension member to be bent into a desired shape to allow selective positioning of said mirror assembly and retaining that shaped until the user bends said extension member again,
(k) wherein said light assembly comprising a light emitting member and a power supply, said power supply being positioned in said handle assembly, said light emitting member being operationally coupled to said power supply such that said power supply is for supplying power to said light emitting member, said light emitting member being adapted for emitting light when said power supply is supplying power to said light emitting member, said light emitting member being coupled to said frame member of said mirror assembly such that said light emitting member is adapted for emitting light to illuminate the portion of the body being viewed in said mirror assembly, and
(l) wherein said light assembly comprising a switch member, said switch member being operationally coupled between said light emitting member and said power supply such that said switch member is for controlling the supply of power from said power supply to said light emitting member when said switch member is actuated by the user, said switch member being coupled to said grip portion said handle assembly such that said switch member is adapted for being actuated by the user when the user is gripping said grip member of said handle assembly.
